(19) United States
(12) Patent Application Publication
(10) Pub. No.: US 2022/0043940 A1
(43) Pub. Date: Feb. 10, 2022

(54) 3D PRINTED EXOSUIT INTERFACE

(71) Applicant: X Development LLC, Mountain View, CA (US)

(72) Inventors: Joseph Hollis Sargent, San Francisco, CA (US); Rhoda Jill Kentin, Oakland, CA (US)

(21) Appl. No.: 16/985,709

(22) Filed: Aug. 5, 2020

(51) Int. Cl. G06F 30/10; G06F 30/20; A41D 13/05; B29C 64/393

(52) U.S. Cl. CPC G06F 30/10; G06F 30/20; G06F 2111/04; B29C 64/393; A41D 13/055

(57) ABSTRACT

Methods, systems, and apparatus, including computer programs encoded on computer storage media, for creating exosuit interfaces using 3D printing. One of the methods includes receiving a three-dimensional data model of one or more areas of a person's body; determining exosuit position data that identifies a portion of the three-dimensional data model for which an exosuit model will be generated; determining an actuator housing location to integrate an actuator housing in a component of the exosuit model, the actuator housing location being determined to align a first movement path for an actuator received in the actuator housing with a second movement path for the person's body; and generating at least a portion of an exosuit model that includes the component having (i) a region shaped to correspond to a contour of the person's body and (ii) an actuator housing at the actuator housing location.

### BACKGROUND

A person may wear an exosuit. The exosuit can include a number of sensors, such as gyroscopes and accelerometers. The exosuit can include control mechanisms that control the movement of the device. Some control mechanisms can include actuators and end effectors.

The exosuit can be any appropriate size. For instance, an exosuit can cover only an upper portion of a user's body. In some examples, an exosuit can include sensors and control mechanisms in only a portion of the exosuit. For example, an exosuit can cover an upper portion of a user's body, e.g., be a shirt, while only including sensors, control mechanisms, and the like in the left arm of the exosuit.

Three-dimensional (“3D”) printers can create physical objects. For instance, a 3D printer can receive a 3D model of an object and create a physical version of the object.

### SUMMARY

A system can generate an exosuit model for a person that is specific to that person. The system can receive data that indicates a three-dimensional model of the person's body and position data that indicates one or more portions of the three-dimensional model for which exosuit components will be generated. For example, when a person has a knee injury, the position data can indicate that the person has a knee injury, e.g., on their right knee. The system can use the data about the injury, e.g., as a health condition, to determine the portions of the three-dimensional model for which exosuit components will be generated. In some implementations, the position data can indicate that an exosuit will be placed on the right knee, e.g., without indicating that the person has a knee injury.

The system uses the position data, and the three-dimensional model, to generate the exosuit model for the person. The exosuit model includes one or more housings for various exosuit components, such as an actuator that assists a person in moving their leg, or a sensor that detects whether the leg is moving and optionally in which direction. For instance, the system can determine a height for the person, or the length of the person's right leg, select an actuator that corresponds to the person's height or right leg length, and generate an exosuit model that includes a housing for the selected actuator, e.g., based on the actuator's dimensions. An actuator can be a component that applies force or causes movement, such as an electric actuator, e.g., a motor, a solenoid, etc., a hydraulic actuator, a pneumatic actuator, and so on.

In some implementations, the system can simulate use of an exosuit using the three-dimensional model of the person's body. The system can determine how a simulated exosuit, based on the exosuit model, interacts with the three-dimensional model of the person's body, and whether the interactions, the exosuit model, or both, satisfy threshold criteria. For example, the system can determine whether a rotation angle for a knee support exosuit is the same as or otherwise aligns with a rotation angle for the right knee of the three-dimensional model. If the rotation angles are not the same, the system can determine changes to the exosuit model. The changes can include changing the actuator for the exosuit model, changing a position of the housing for the actuator in the exosuit model, or other appropriate changes.

Once the system generates the exosuit model, the system can send data for the exosuit model to a three-dimensional printer. For instance, the system can send instructions, based on the exosuit model, to the three-dimensional printer that cause the three-dimensional printer to create a corresponding exosuit that includes housings for actuators and other exosuit components in the positions defined by the exosuit model.

A person can then use the created exosuit to help them with a health condition, such as a knee injury or a disease, e.g., cerebral palsy. Because the exosuit was created using a personalized exosuit model and a three-dimensional model of the person's body, the exosuit can provide more accurate support for the person, weigh less than other exosuits, or both. For example, the system can create a personalized exosuit model that has a size, material properties, or both, using data for the person's health conditions, a use type, e.g., running or walking, or both.

In general, one aspect of the subject matter described in this specification can be embodied in methods that include the actions of receiving a three-dimensional data model of one or more areas of a person's body; determining exosuit position data that identifies a portion of the three-dimensional data model for which an exosuit model will be generated, the portion of the three-dimensional data model corresponding to a portion of the person's body included in the one or more areas of the person's body; determining, using the three-dimensional data model and the exosuit position data, an actuator housing location to integrate an actuator housing in a component of the exosuit model, the actuator housing location being determined to align a first movement path for an actuator received in the actuator housing with a second movement path for the person's body; and based on the three-dimensional data model, the exosuit position data, and the actuator housing location, generating at least a portion of an exosuit model that includes the component having (i) a region shaped to correspond to a contour of the person's body and (ii) an actuator housing at the actuator housing location. Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The method can include selecting an attachment feature that is configured to attach the actuator to the actuator housing. Generating at least the portion of the exosuit model can include generating at least the portion of the exosuit model that includes the component having the actuator housing at the actuator housing location and the attachment feature connected to the actuator housing.

In some implementations, the method can include determining a component of a template exosuit model located within a threshold distance of the actuator housing location using the exosuit position data and the actuator housing location. Generating at least the portion of the exosuit model that includes the component can include customizing the component from the template exosuit model to have the actuator housing at the actuator housing location. Determining the component of the template exosuit model located within the threshold distance of the actuator housing location can include selecting a support component that is located at the actuator housing location. The method can include determining whether a size for the component satisfies one or more criteria using one or more properties for the actuator. Customizing the component from the template exosuit model to have the actuator housing at the actuator housing location can include customizing the component from the template exosuit model to have the actuator housing at the actuator housing location and a size that satisfies the one or more criteria when the size does not satisfy the one or more criteria. Determining the component of the template exosuit model located within the threshold distance of the actuator housing location can include selecting a component from multiple components included in the template exosuit model using the size for the component and the actuator housing locations. Determining the actuator housing location can include determining a region of the template exosuit model in which to place the actuator housing for the actuator; determining two or more exosuit components that are in the region of the template exosuit model; selecting, from the two or more exosuit components, a component in which to place the actuator housing using one or more of a strength for the component, a size for the component, or a flexibility for the component. The one or more properties for the actuator can include one or more of an actuator size, an actuator weight, or an actuator power.

In some implementations, the method can include providing, to a three-dimensional printer, the exosuit model and an instruction to print one or more components of a physical exosuit based on the exosuit model. Determining the actuator housing location to align a first movement path for an actuator received in the actuator housing with a second movement path for the person's body can include determining an actuator housing location that aligns a position of an actuator, placed in the actuator housing at the actuator housing location, with a center of a joint for the portion of the person's body. Determining the actuator housing location to align a first movement path for an actuator received in the actuator housing with a second movement path for the person's body can include determining an actuator housing location to align movement of an actuator, placed in the actuator housing at the actuator housing location, with movement of a joint for the portion of the person's body.

In some implementations, determining the exosuit position data can include receiving the exosuit position data that identifies the portion of the three-dimensional data model that corresponds to a portion of the person's body that has a health condition. The method can include determining, using the three-dimensional data model and the exosuit position data, a sensor housing location to integrate a sensor housing in a second component of the exosuit model, the sensor housing location being determined to enable a sensor, received in the sensor housing, to monitor the person's body or an environment in which the person's body is located. Generating at least the portion of the exosuit model can include generating at least the portion of the exosuit model that includes the second component having (i) a second region shaped to correspond to a contour of the person's body and (ii) a sensor housing at the sensor housing location.

In some implementations, the method can include determining, using the three-dimensional data model and the exosuit position data, a cable housing location to integrate a cable housing in a second component of the exosuit model, the cable housing location being determined to enable a cable, received in the cable housing, to connect a control board with another component of an exosuit while minimizing an amount that movement of a person's body is limited by the cable. Generating at least the portion of the exosuit model can include generating at least the portion of the exosuit model that includes the second component having (i) a second region shaped to correspond to a contour of the person's body and (ii) a cable housing at the cable housing location. The method can include determining, using the three-dimensional data model and the exosuit position data, a control board housing location to integrate a control board housing in a second component of the exosuit model, the control board housing location being determined to minimize an amount of movement of a person's body that is limited by a control board received in the control board housing. Generating at least the portion of the exosuit model can include generating at least the portion of the exosuit model that includes the second component having (i) a second region shaped to correspond to a contour of the person's body and (ii) a control board housing at the control board housing location.

In some implementations, the method can include simulating a use of an exosuit using the exosuit model and the three-dimensional data model of the one or more areas of the person's body. The method can include determining whether data for the simulation satisfy one or more threshold criteria; and in response to determining that data for the simulation satisfy the one or more threshold criteria, storing the exosuit model in a memory and determining to not modify the exosuit model. The method can include determining whether data for the simulation satisfy a threshold criteria; and in response to determining that data for the simulation does not satisfy the threshold criteria, modifying one or more parameters for the exosuit model using the data that do not satisfy the threshold criteria.

In some implementations, generating at least the portion of the exosuit model can include generating at least the portion of the exosuit model using one or more structural integrity design rules. Generating at least the portion of the exosuit model can include selecting a fabrication material for a physical exosuit that can be created using the exosuit model, or a size of one or more components for the exosuit model while minimizing a weight for the physical exosuit and maintaining a minimum strength for the physical exosuit.

The subject matter described in this specification can be implemented in various embodiments and may result in one or more of the following advantages. In some implementations, an exosuit model generation system can generate a personalized exosuit model that is customized for a particular person, for a health condition of the particular person, or both. The exosuit model generation system can generate the personalized exosuit model to minimize a weight, a size, or both, of a corresponding exosuit while providing adequate support for the particular person, e.g., based on the health condition. In some implementations, an exosuit model generation system can generate a personalized exosuit model customized to a particular person's body shape, body movement, or both. Such an exosuit can have an improved effectiveness. For example, the exosuit model generation system can determine locations for exosuit component housings so that movement provided by the exosuit aligns with the particular person's body movement, e.g., when different people's bodies move in different ways. An improved effectiveness can reduce an amount of energy used by a personalized exosuit. In some implementations, an exosuit model generation system can generate a personalized model for an exosuit that has a reduced likelihood of injuring an exosuit user while the user is wearing the exosuit.

In some implementations, the disclosed techniques can provide process advantages during the design, creation, or both, of personalized exosuits. For example, an exosuit model generation system can customize an existing exosuit data model, e.g., a template data model or a data model for a particular health condition, for each person for whom the system generates a personalized exosuit model. By customizing an existing data model, the system can remove the need to create a data model for each person, e.g., a personalized data model from scratch. That is, the system can be more efficient than custom designing a new exosuit data model, a new exosuit, or both. Accordingly, the process advantages of the system can include improved personalized exosuit design efficiency, e.g., by reducing the time needed for personalized exosuit development, by reducing the resources required for personalized exosuit development, or both.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which an exosuit model generation system generates a personalized exosuit model.

FIG. 2 is a flow diagram of a process for generating a personalized exosuit model.

Like reference numbers and designations in the various drawings indicate like elements.

### DETAILED DESCRIPTION

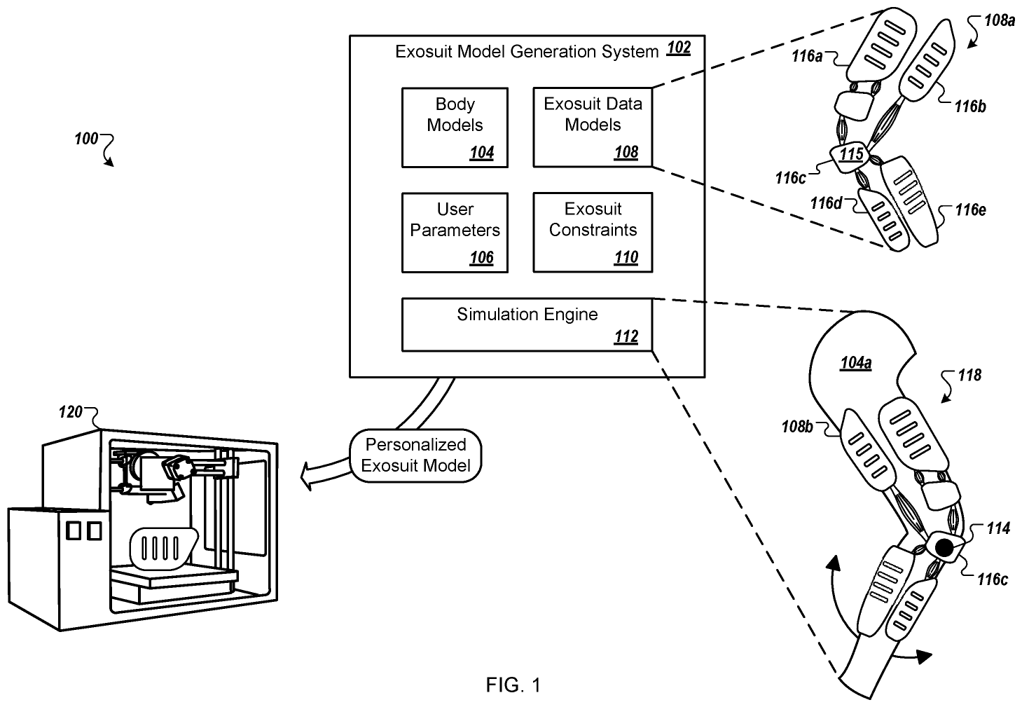

FIG. 1 depicts an example environment 100 in which an exosuit model generation system 102 generates a personalized exosuit model 108a. The exosuit model generation system 102 uses a body model 104 for a person to generate the personalized exosuit model 108a that is specific to that person, e.g., the contours of the person's body, the person's health condition, or both. The personalized exosuit model 108a can be a three-dimensional (“3D”) model for an exosuit. A three-dimensional printer 120, or another system, can use the personalized exosuit model 108a to create, e.g., print, components of the exosuit for the person.

In some implementations, the system 102 can be used to design exosuits that are worn under clothes or are integrated into a garment. Unlike some exosuit designs, this application can constrain the size and weight of the exosuit. In general, it is desirable for the exosuit to fit as close to the body and with minimal weight possible while providing the mechanical assistive functions of the exosuit.

One of the challenges of creating an effective exosuit is achieving a very precise fit for the wearer's body. Each person has a unique size and shape, and components need to fit precisely with respect to the person's anatomy. For example, the components need to align with joint movement to provide appropriate kinematics. It is also desirable for the exosuit to fit properly and distribute forces evenly to avoid areas of higher pressure that may be uncomfortable. In addition, it is important for the exosuit to avoid slipping while worn and to avoid being too tight, and to avoid interference with user movement. Improper fit can make an exosuit ineffective or in some cases lead to scrapes or bruises for the wearer. The fit and placement of exosuit components can be determined from a 3D model of at least a portion of a person's body, for example, based on images or a 3D scan of the person. The system 102 can generate the personalized exosuit model 108a so that components match the contours of the user's body, which helps the exosuit properly engage the user's body and remain in the proper position when worn.

In some implementations, a 3D-printed component of a personalized exosuit can include one or more housings or attachment features for attaching other exosuit components. The other components can include actuators, sensors, cables, control boards, or other components. The housings can be attachment features that can be used to secure components in a desired position, e.g., location and/or orientation. The precise placement of components in the exosuit can often be very important to obtain a functional exosuit. For example, actuators, e.g. motors, pneumatic cylinders, etc., may need to be placed carefully to align with the user's natural joint movement and provide the kinematics needed. Otherwise, misaligned actuators could potentially operate with reduced efficiency, feel awkward to the user, or hinder proper movement. As another example, sensors may need to be placed carefully to be able to record accurate information to control the exosuit and to indicate status of the exosuit.

For example, structural, load-bearing components of the exosuit can be designed to include one or more surfaces that match, e.g., complement, the contours of a user's body to provide proper fit and distribution of force. One example is a weight-bearing panel configured to engage a user's thigh in a lower-body exosuit. The panel can include a body-contoured surface and include one or more housings that are integrally formed in the component. For example, a panel of an exosuit can include a body-contoured surface on one side and an actuator housing on another side, with the actuator housing configured to receive and secure an actuator at a predetermined location and orientation with respect to the panel. This can provide several advantages. For example, the body-contoured surface of the component can facilitate placement of the panel with respect to the user's body, and the integrated actuator housing can set the location and position of an actuator. Thus, the combination of body-contoured surface and actuator housing can precisely place the actuator in the desired position with respect to the user's body when worn. This can align movement of the exosuit, caused by the actuator, to align with the user's body movement.

In addition, including a component housing in a 3D-printed structural component of the exosuit can lead to significant weight savings and size reductions. For an exosuit integrated into or worn under clothes, or more generally for an exosuit intended for general daily mobility assistance, minimizing weight and bulk is important to make the exosuit usable. Including component housings into the components that form the load-bearing structure of the exosuit reduces component count and can reduce the amount of material and thus weight used for an exosuit. For example, attaching a housing element to a panel of an exosuit would add a component to the panel and would add accompanying weight and bulk. By contrast, the exosuit model generation system 102 can design the panel to include the housing, by defining an aperture, recess, or other space in the panel that allows another component, e.g., actuator, sensor, cable, battery, control electronics, etc., to be partially or completely recessed into the panel. As a result, the panel includes less material, and thus has less weight, while also reducing the overall size of the exosuit by allowing another component to at least partially rest within the recess that the housing defines in the panel.

The size, shape, location, orientation, and other properties of component housings can be customized for the particular user's body. As a result, the type of component housing can vary depending on the type and size of actuator needed, allowing the components of the exosuit to vary according to the functional needs of the user. For example, a particular motor to be used in an exosuit can be selected based on the body shape and assistance needs of a particular user. Once a motor with the appropriate characteristics is selected, the exosuit model generation system 102 can modify the design of a component of an exosuit to include a motor mount for the selected motor, with the motor mount location and orientation in the component being customized for the anatomy of the user. This can include defining the motor mount with the specific size and shape for receiving the selected motor, as well as including alignment features, attachment features, and other characteristics selected to align and secure the motor into the component in an orientation selected based on the user's anatomy.

In the example of FIG. 1, the exosuit model generation system 102 receives a body model 104. The body model can be a three-dimensional data model that indicates a size, shape, or both, of a person's body, e.g., a person who will wear a personalized exosuit. The exosuit model generation system 102 can receive the body model 104 from one or more sensors, e.g., a 3D scanner. The exosuit model generation system 102 can receive the body model 104 from another system that generated the body model 104, e.g., using data from one or more sensors. In this document, a body model 104 can refer to a model of a person's entire body, or a portion of a person's body, e.g., a portion for which the person has a health condition, such as the person's leg or arm.

The exosuit model generation system 102 determines a portion of the body model 104 for which the exosuit model generation system 102 will generate a personalized exosuit model 108a. For instance, the exosuit model generation system 102 can receive data with the body model 104 for a person that indicates a portion of the body model 104 for which the exosuit model generation system 102 can generate an exosuit model. In this example, the exosuit model generation system 102 can receive data that indicates “left elbow.” The exosuit model generation system 102 can use this data to determine the portion of the body model 104 that represents a person's left elbow. The exosuit model generation system 102 can use data for this portion of the body model 104 to generate a personalized exosuit model 108a for a left elbow. The body model 104 can be for the person's entire body, for the person's upper body, or another part of the body that includes the person's left elbow.

In some implementations, the exosuit model generation system 102 receives a partial body model 104 that identifies the portion for which to generate a personalized exosuit model 108a. For instance, the exosuit model generation system 102 can receive a body model 104 that only includes data for an area around the person's left elbow. The body model 104, e.g., a partial body model, can model a sufficient portion of the person's body to enable the exosuit model generation system 102 to generate a personalized exosuit model 108a for the person. For instance, the body model 104 can be a model of the person's left arm, e.g., the left aftarm and the left forearm.

In some implementations, the exosuit model generation system 102 can receive data that indicates a health condition for which the exosuit model generation system 102 will generate a personalized exosuit model 108a. For instance, the exosuit model generation system 102 can receive data with the body model 104 for a person that indicates a health condition of the person. Some examples of health conditions include a left elbow injury, a need for additional support in a right knee, a recent surgery the person underwent, that the person has a particular disorder, e.g., Parkinson's, amyotrophic lateral sclerosis, cerebral palsy, etc., or a combination of two or more of these.

The exosuit model generation system 102 uses the data that indicates a portion of the body model 104 to generate the personalized exosuit model 108a. For example, the exosuit model generation system 102 can select, from one or more exosuit data models 108, a template exosuit data model that is specific to the portion of the body model 104, to the person's health condition, or both. When the person has a left elbow injury, the exosuit model generation system 102 can select a template exosuit model for a left arm exosuit that is congruent with the left arm in the body model 104. The exosuit model generation system 102 can customize the template exosuit model based on the body model 104, one or more user parameters 106 for the person for whom the personalized exosuit model is being generated, one or more exosuit constraints 110, or a combination of two or more of these.

A template exosuit model can be congruent with a portion or all of a body model 104 when the template exosuit model would fit over the respective portion or entire body model 104, e.g. in a simulated environment. The fit can satisfy one or more threshold criteria, e.g., that a portion of the template exosuit model is within a first threshold distance from a respective part of a body model 104, more than a second threshold distance, or both. For instance, the exosuit model generation system 102 can use the first threshold distance to ensure that the personalized exosuit model 108a is not too loose compared to the body model 104 and the second threshold distance to ensure that the personalized exosuit model 108a is not too tight compared to the body model 104.

The exosuit model generation system 102 can include multiple exosuit data models 108 each of which are congruent with a different body model 104, different portion of a body model 104, e.g., an arm or a leg, or a combination of both. The exosuit data models 108 can be for different portions of a body, different body shapes, different body sizes, different body features, or a combination of two or more of these. Some examples body features can include whether a limb has an abnormal shape, e.g., was previously broken and didn't heal correctly; a body is missing a limb; has an extra limb, e.g., an extra finger; or another appropriate feature.

In some implementations, the exosuit model generation system 102 can generate one or more of the exosuit data models 108. For instance, the exosuit model generation system 102 can receive a body model 104, and analyze data for a health condition to determine to which parts of the body model 104 a personalized exosuit model 108 should be congruent. The exosuit model generation system 102 can then determine locations on the body model 104 to which components of an exosuit correspond and create a new exosuit data model by aligning the components with the locations on the body model 104.

For example, the exosuit model generation system 102 can determine that an actuator corresponds with an elbow position in the body model 104, and that one or more plates 116a-e correspond to positions on the aftarm and forearm of the body model. The exosuit model generation system 102 can then generate a personalized exosuit model 108a-b that includes a component housing 114 in a plate 116c at the elbow position opposite a region 115 of the plate 116c that is shaped to correspond to a contour of the body model 104, e.g., that has a contour that is similar to the contour of corresponding part of the body model 104 to which the plate 116c aligns. The exosuit model generation system 102 can select a size, a shape, or both, for the component housing 114 based on an actuator that can be included in an exosuit created using the personalized exosuit model 108a. As a result, the component housing 114 can be an aperture, recess, or other attachment feature for an actuator. In a similar manner, housings or attachment features can be selected and placed for other components of a personalized exosuit, such as sensors, cables, batteries, control electronics, and so on.

In general, a housing can include a space defined in a component, such as a recess, groove, channel, aperture, opening, and so on. The space can be sized, shaped, and oriented to receive at least a portion of another component, such as an actuator or sensor. In some implementations, the space is designed to complement or match the contours of at least portions of the component to be received in the housing. A housing may additionally or alternatively include other features for alignment and attachment of a component, such as a projection, protrusion, rail, clip, etc.

The exosuit model generation system 102 can select the actuator based on the support a personalized exosuit will provide a person, e.g., an amount of support, a location where the actuator will be positioned, or another appropriate value. For example, the exosuit model generation system 102 can select a first, larger actuator for a personalized knee exosuit and a second, smaller actuator for a personalized elbow exosuit. The exosuit model generation system 102 can generate the personalized exosuit model 108a that includes the plates 116a-e and the aftarm and forearm positions, e.g., such that the corresponding exosuit will provide support to one or more of those aftarm, forearm, or both, positions.

In some implementations, the exosuit model generation system 102 can customize a template exosuit data model 108. For example, the exosuit model generation system 102 can select a template exosuit data model 108 and make one or more customizations to the template exosuit data model 108 to create the personalized exosuit model 108a. The customizations can include selecting a location for the component housing 114, a size for the component housing 114, locations or sizes for one or more of the plates 116a-e, another appropriate customization, or a combination of two or more of these. The customizations can be based on the contour of the region 115 that corresponds to the contour of the body model 104, e.g., and a corresponding portion of a person's body.

The exosuit model generation system 102 can generate the personalized exosuit model 108a using one or more user parameters 106. The user parameters 106 can include data for the person's health condition, the person's weight, the person's height, the person's muscle mass, a use type, other appropriate parameters, or a combination of two or more of these. A use type can indicate how a personalized exosuit created using the personalized exosuit model 108a will likely be used, e.g., walking, running, or climbing.

In some implementations, the exosuit model generation system 102 can determine some of the user parameters 106 using a body model 104 for the person. For instance, the exosuit model generation system 102 can determine a person's aftarm length and forearm length using the person's body model 104. The exosuit model generation system 102 can use the aftarm length and the forearm length as some of the user parameters 106.

In some implementations, the exosuit model generation system 102 can receive data that identifies one or more of the user parameters 106. For instance, the exosuit model generation system 102 can receive data that indicates user input of some of the user parameters 106. The exosuit model generation system 102 can receive the data when the exosuit model generation system 102 receives the body model 104 for the person. In some implementations, the exosuit model generation system 102 can receive the data separately from the receipt of the body model 104 for the person.

The user parameters 106 can include data that indicates a type of clothing to which a personalized exosuit, created using the personalized exosuit model 108a, will couple. For example, the exosuit model generation system 102 can use the user parameters 106 to generate a personalized exosuit model 108a for an exosuit that will be integrated with a person's clothing. This can reduce a weight for the exosuit as the exosuit model generation system 102 does not need to generate as many components for the personalized exosuit model 108a compared to an exosuit that would not be coupled with a person's clothing.

The exosuit model generation system 102 can use one or more exosuit constraints 110 when generating the personalized exosuit model 108a. The exosuit constraints 110 can be system constraints on a personalized exosuit design, e.g., in contrast to the user parameters 106 that are for a person likely to wear a personalized exosuit. The exosuit constraints 110 can indicate structural integrity design rules for an exosuit, e.g., minimum thicknesses for various materials optionally based on a use type, maximum flexibility parameters, or both. The structural integrity design rules can be any appropriate structural integrity design rules. The exosuit constraints 110 can include rules for different types of exosuit fabrication materials, different types of components, or both. Some examples of exosuit fabrication materials include carbon, plastic, or rubber, e.g., for edges or flexible components.

When generating a personalized exosuit model 108a, the exosuit model generation system 102 can select an exosuit fabrication material based on a health condition, a use type for the exosuit, or both. For instance, the exosuit model generation system 102 can select a stronger, more flexible, or both, exosuit fabrication material for an elbow personalized exosuit model that will be used to generate a personalized exosuit for a climber compared to a personalized exosuit model that will be used to generate a personalized exosuit for a walker or a hiker. In this example, the use types can be climbing, and walking, or hiking.

The exosuit model generation system 102 can use the exosuit constraints 110 to generate a personalized exosuit model 108a for an exosuit that will have a minimal weight given the other requirements for the exosuit, e.g., the user parameters 106. For example, the exosuit model generation system 102 can balance features for the personalized exosuit model 108a that will add weight to a personalized exosuit with features that will provide sufficient support, sufficient strength, sufficient flexibility, or a combination of these, based on the use type for the personalized exosuit, a person's health condition, or both.

The exosuit constraints 110 can include constraints for components for an exosuit. For instance, the exosuit constraints 110 can indicate actuator parameters, support parameters, size parameters, or a combination of two or more of these, for a personalized exosuit model 108a. Actuator parameters can indicate a range of actuator requirements given a particular health condition, a particular use type, corresponding user parameters 106, or a combination of two or more of these. For instance, the exosuit model generation system 102 can select a first actuator type, e.g., with a smaller motor, for a first personalized exosuit model with a hiking use type and for a first person who is shorter than a second person for which the exosuit model generation system 102 generates a second personalized exosuit model with a second actuator type, e.g., with a larger motor, and a climbing use type.

In addition to actuators, components can include sensors, cables, or a control board. The exosuit model generation system 102 can use the exosuit constraints 110, the user parameters 106, the exosuit data models 108, or a combination of these, to determine locations for these components in the personalized exosuit model 108a. For example, the exosuit data models 108 can include, for a first exosuit data model, a first position for a particular cable in a left arm exosuit. A second exosuit data model can include a second position for the particular cable in a left arm exosuit. The differences in the positions can be based on the size of the corresponding models, use types for the corresponding models, or another appropriate parameter or constraint or both.

In general a component can refer to any part of an exosuit. As an example, exosuit components can include anatomy support components (“support components”) and connector components. Support components can, when compared to connector components, be designed to contact a relatively large surface area of a person's body. For instance, support components can be designed so that they are contoured to a portion of a person's body, such as to particular anatomical structures of the person. Support components can include, for example, plates, cups, straps, etc. Support components can be made out of plastics, composites such as carbon fiber, metal, metal alloys, etc.

Connector components can be designed and used to form connections between other components, including support components and/or other connector components. For example, connector components can be designed so that they are contoured to a portion of a person's body. Connector components can be used, for example, to form hinges, as support bars or beams, to provide force, or a combination of these. As an example, connector components can include pneumatic or hydraulic artificial muscles that provide a contractile and/or extensional force when triggered.

Once the exosuit model generation system 102 generates a personalized exosuit model 108a, a simulation engine 112 in the exosuit model generation system 102 can simulate 118 the use of the personalized exosuit model 108b. The simulation engine 112 can determine one or more simulations for the personalized exosuit model 108b based on the health condition of a person who will wear a corresponding personalized exosuit, some of the user parameters 106, e.g., a use type, or both. For instance, the simulation engine 112 can determine activities for which a personalized exosuit will likely be used and simulate 118 those activities in a simulated environment. For an elbow injury, some example activities can include bending the elbow, rotating the shoulder, swimming, lifting an object, throwing an object, or pulling an object. For a knee injury, some example activities can include walking, running, hiking, swimming, pushing or pulling an object, going up or down stairs, sitting, standing, or jumping.

During the simulation 118, the simulation engine 112 can analyze the performance of the personalized exosuit model 108b to determine whether the exosuit model generation system 102 should make any changes to the personalized exosuit model 108b. For instance, the simulation engine 112 can simulate 118 rotation of an arm that is wearing a personalized exosuit created based on the personalized exosuit model 108b. The simulation engine 112 can determine whether a position of the component housing 114 in which an actuator is located is optimized, e.g., most likely aligns with the movement of the arm during rotation compared to other potential locations.

In FIG. 1, the personalized exosuit model 108a and the personalized exosuit model 108b, for the simulation 118, can be the same personalized exosuit model. For instance, the personalized exosuit model 108a is a depiction of the back side of the personalized exosuit model 108, e.g., that corresponds to a portion of a personalized exosuit that would be closest to, and face toward, a person's body. This portion of the personalized exosuit model can include the region 115 shaped to correspond to a contour of the person's body, e.g., the exosuit model generation system 102 can generate this portion to have a contour that corresponds to the contour of the person's body. The personalized exosuit model 108a includes the component housing 114 in a corresponding location of the personalized exosuit model 108b but on the opposite side of the personalized exosuit model 108a from that shown, e.g., on the side furthest from the side that is closest to the person's body. Each of the components in the personalized exosuit model 108a can be shaped to correspond to corresponding contours of the person's body, e.g., based on the body model 104.

The personalized exosuit model 108b is a depiction of the front side of the personalized exosuit model 108, e.g., that corresponds to a portion of a personalized exosuit that would be furthest from, and face away from, a person's body. The personalized exosuit model 108b includes the component housing 114 in a corresponding location of the personalized exosuit model 108b in the plate 116c.

The exosuit model generation system 102 can receive output from the simulation engine 112 that indicates the performance of a personalized exosuit based on the personalized exosuit model 108a-b. The output can indicate areas for the personalized exosuit model 108a-b that are not likely to hinder a user's movement, are likely to hinder a user's movement, that can be further optimized, e.g., are not the best fit for a corresponding portion of the body model 104a, or a combination of two or more of these.

The exosuit model generation system 102 can use the received output to update the personalized exosuit model 108a. For example, if the output indicates that elbow rotation was not smooth, the exosuit model generation system 102 can select a different sized actuator, adjust a location of the component housing 114, adjust a size of a component in which the component housing 114 is located, e.g., the plate 116c, adjust a size or location of a strap that connects two plates in the personalized exosuit model 108a-b, or a combination of two or more of these.

For instance, when the size of the component does not satisfy one or more criteria, the exosuit model generation system can adjust the component size so that the component satisfies the one or more criteria. The criteria can be criteria for at least one of component strength, component size, e.g., sufficient to encompass the component housing, or another appropriate criteria.

The exosuit model generation system 102 can then provide the updated personalized exosuit model 108a-b to the simulation engine 112. The simulation engine 112 can then perform one or more additional simulations 118 using the updated personalized exosuit model 108b. The additional simulations can test the criteria for which the exosuit model generation system 102 made adjustments to the personalized exosuit model 108a-b since the prior simulation, criteria that were not the basis of the adjustments, or both. For example, the simulation engine 112 can test all of the threshold criteria for the personalized exosuit model 108a-b using corresponding simulations.

The exosuit model generation system 102 can continue this iterative process until the personalized exosuit model 108a-b satisfies one or more threshold criteria. The threshold criteria can indicate simulation requirements for the personalized exosuit model 108b in a simulation 118. For instance, the threshold criteria can indicate that the exosuit model generation system 102 should minimize a reduction in freedom of movement for a body model 104a that is caused by a personalized exosuit model 108b during a simulation 118. When the exosuit model generation system 102 is unable to further reduce any reduction in freedom of movement, e.g., after a threshold number of iterations, the threshold criteria can be satisfied. Threshold criteria can indicate requirements for freedom of movement, e.g., of one or more body parts, exosuit weight, exosuit support, other appropriate requirements, or a combination of these.

When the personalized exosuit model 108a-b satisfies any threshold criteria, the exosuit model generation system 102 can provide the personalized exosuit model 108a-b to a three-dimensional printer 120. The three-dimensional printer 120 can use the personalized exosuit model 108a-b to create a personalized exosuit, e.g., for a user. In some implementations, the three-dimensional printer 120 can create all components of the personalized exosuit using the personalized exosuit model 108a-b. In some situations, the three-dimensional printer 120 can create a subset of the components for the personalized exosuit. For example, the three-dimensional printer 120 can create support components and connector components while not creating actuators, batteries, and other components for the personalized exosuit.

The exosuit model generation system 102 is an example of a system implemented as computer programs on one or more computers in one or more locations, in which the systems, components, and techniques described in this document are implemented. The exosuit model generation system 102 may use a single computer or multiple computers operating in conjunction with one another, including, for example, a set of remote computers deployed as a cloud computing service.

The exosuit model generation system 102 can include several different functional components, including the simulation engine 112. The simulation engine 112 can include one or more data processing apparatuses. For instance, the simulation engine 112 can include one or more data processors and instructions that cause the one or more data processors to perform the operations discussed herein.

The various functional components of the exosuit model generation system 102 may be installed on one or more computers as separate functional components or as different modules of a same functional component. For example, the simulation engine 112 can be implemented as computer programs installed on one or more computers in one or more locations that are coupled to each through a network. In cloud-based systems for example, these components can be implemented by individual computing nodes of a distributed computing system.

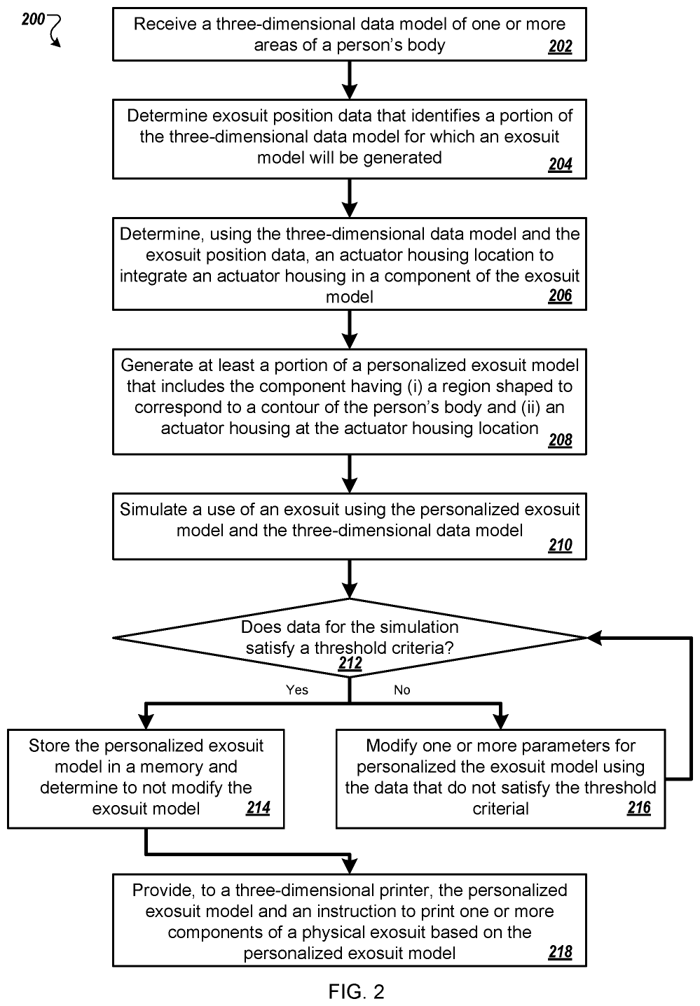

FIG. 2 is a flow diagram of a process 200 for generating a personalized exosuit model. For example, the process 200 can be used by the exosuit model generation system 102 from the environment 100. Although the process 200 is described with respect to determining locations for one or more actuator housings, a system can perform the process 200 for housings for different types of components, for combinations of components, or both. For instance, a system can perform the process 200 for an actuator, a sensor, a cable, a battery, a control board, or perform the process multiple times for a combination of these components.

An exosuit model generation system receives a three-dimensional data model of one or more areas of a person's body (202). For example, the exosuit model generation system receives the three-dimensional data model, e.g., a body model, from a system that uses one or more scanners, cameras, other sensors, or a combination of these, to create the three-dimensional data model. The areas of the person's body can be the upper body, the lower body, the torso, a limb, the head, or a combination of two or more of these.

The exosuit model generation system determines exosuit position data that identifies a portion of the three-dimensional data model for which an exosuit model will be generated (204). The portion of the three-dimensional data model can correspond to a portion of the person's body included in the one or more areas of the person's body. For instance, the portion of the three-dimensional data model can correspond to a portion of the person's body that a personalized exosuit, generated using a personalized exosuit model, can support. The portion of the person's body can be injured or otherwise require support, e.g., based on age or disease. When the areas of the person's body include an upper body, the portion can be the person's left arm, or right shoulder.

In some implementations, the position data can identify a particular part of the three-dimensional data model. For example, the position data can identify a knee or an elbow as the portion of the three-dimensional data model. The position data can identify coordinates of the three-dimensional data model based on a reference point for the model. The coordinates can indicate the portion of the three-dimensional data model, e.g., a knee or an elbow, for which the exosuit model will be generated.

In some implementations, the position data can identify a problem area, e.g., a general region, for which an exosuit model will be generated. For instance, when a person has a knee injury on their left leg, the position data can identify the left leg, e.g., rather than the left knee.

In some implementations, the position data can identify areas in which exosuit components will be placed. For instance, the position data can indicate that exosuit components should be generated for a front left side of a left leg.

In some implementations, the system can determine data for a potential housing location, type of clothing to which the exosuit will attach, or other appropriate data. The potential housing location can be for an actuator or another component that will be added to a personalized exosuit suit after the personalized exosuit is created by a three-dimensional printer. The type of clothing can be any appropriate type of clothing, such as sweatpants or jeans for a personalized knee exosuit, or clothing that includes one or more pockets for various components of a personalized knee exosuit.

The exosuit model generation system determines, using the three-dimensional data model and the exosuit position data, an actuator housing location to integrate an actuator housing in a component of the exosuit model (206). The exosuit model generation system can determine the actuator housing location to align a first movement path for an actuator received in the actuator housing with a second movement path for the person's body. The exosuit model generation system can determine an actuator housing location to align an actuator, placed in a housing at the housing location, to align with a corresponding joint center, actuator movement with joint movement, or both. For instance, when the joint is an elbow, the exosuit model generation system can determine an actuator housing location such that an actuator placed in a housing at the location will align with the center of the elbow. To actuator movement aligns with joint movement, the exosuit model generation system can determine an angle of rotation for the joint, e.g., elbow, and select an actuator that has the same angle of rotation. The exosuit model generation system can then determine the actuator housing location so that the actuator angle of rotation aligns with the joint angle of rotation.

The exosuit model generation system can determine the actuator housing location to align the actuator housing with contours of a person's body, an angle of movement of a corresponding joint in the person's body, or both. For instance, the exosuit model generation system can determine an angle for the actuator housing location, with respect to the component or an exosuit model, such that an actuator that is received by the actuator housing will have an angle of movement that aligns with movement of the person's body, e.g., a corresponding joint.

The exosuit model generation system can determine an actuator housing location to integrate the housing, an actuator placed in the housing, or both, with other components of a personalized exosuit model. For instance, the exosuit model generation system can select a plate of sufficient size for the housing, e.g., large enough to surround the housing, and include data in a personalized exosuit model for the plate in an area that includes the actuator housing location. The exosuit model generation system can generate the personalized exosuit model, as discussed in more detail below, to include the plate in the area that includes the actuator housing location.

In some implementations, determining the one or more actuator housing locations can include selecting one or more actuators, each of which can be positioned in a corresponding housing. For instance, the exosuit model generation system can determine a number of actuators for a personalized exosuit model, e.g., using data about a health condition for which a personalized exosuit will provide support, one or more user parameters, one or more exosuit constraints, or a combination of two or more of these. The exosuit model generation system can determine a size, type, or both, for an actuator using data about the health condition, one or more user parameters, e.g., a use type, or both. The exosuit model generation system can determine performance requirements for a personalized exosuit, e.g., using data about the health condition, one or more user parameters, or both. The exosuit model generation system can use the performance requirements to select an actuator.

After selecting an actuator, the exosuit model generation system can determine size requirements for a housing that can hold the actuator. The size requirements can include a length, width, height, shape, or a combination of these. The exosuit model generation system can determine an actuator housing location using the size requirements for the housing. For example, the exosuit model generation system can select a first location for a first, larger width and smaller height, e.g., the backside of an elbow joint, or a second location for a second, shorter width and longer height, e.g., the side of an elbow joint.

In some implementations, determining the one or more actuator housing locations can include selecting an appropriate type of actuator mount. For instance, the exosuit model generation system can determine whether to include an integrated mount, e.g., that is part of a personalized exosuit created by a three-dimensional printer using the personalized exosuit model, or an external actuator mount that fits into an actuator housing to hold an actuator in place in the housing. The exosuit model generation system can use data for the actuator mount to determine the actuator housing location, such as a size of the actuator mount, a layout for the actuator mount, or both. The layout can indicate where, how, or both, the actuator mount connects to the personalized exosuit. The exosuit model generation system can align the actuator mount with one or more other components for a personalized exosuit, e.g., components that connect to the actuator mount; with a predicted movement path for a corresponding part of a person's body; or both.

In some implementations, the exosuit model generation system can determine properties for an actuator mount using properties for an actuator that the actuator mount will secure. For instance, the exosuit model generation system can determine an actuator mount material, such as plastic or carbon, using properties for the actuator. The exosuit model generation system can select a stronger material for a heavier actuator. The exosuit model generation system can select a lighter material for a lighter actuator.

In some implementations, the exosuit model generation system can determine properties for an actuator mount using a use type for a personalized exosuit that can be created using a personalized exosuit model. For instance, the exosuit model generation system can select a lighter actuator mount for a personalized exosuit that will be used for lighter activities, e.g., walking, and select a stronger actuator mount for a personalized exosuit that will be used for more demanding activities, e.g., climbing or running.

When the exosuit model generation system determines one or more sensor housing locations, the exosuit model generation system can use data that indicates what the sensors will monitor when determining the corresponding sensor housing locations. For example, the exosuit model generation system can determine a housing location that will enable a sensor, connected to a corresponding housing at the housing location, to detect data for which the sensor is monitoring. When the sensor is monitoring a portion of a user's body, the exosuit model generation system can determine a housing location that enables the sensor to monitor that portion of the user's body, e.g., without other exosuit components preventing the sensor from monitoring that portion of the user's body. When the sensor is monitoring something other than the user's body, such as a leg exosuit sensor detecting objects in the user's path to guide the user around such objects, the exosuit model generation system can determine a corresponding sensor housing location that enables the sensor to detect objects in the user's path.

In some implementations, the exosuit model generation system can optimize a housing for flexibility parameter for a corresponding component that can mount onto the housing. For instance, the exosuit model generation system can generate an actuator housing with a higher rigidity than a cable housing. The exosuit model generation system can generate the cable housing based on flexibility of the cable, flexibility of the user who can wear the exosuit, flexibility of a material from which the housing will be created, or a combination of these.

In some examples, the exosuit model generation system can generate the cable housing using a comfort parameter. A comfort parameter for a housing, or a component, can indicate a likely degree of comfort for a user wearing an exosuit that includes the housing. The exosuit model generation system can predict the comfort parameter using a material for the corresponding housing, a flexibility of the corresponding housing, a predicted coefficient of friction between an exosuit and a user, or another appropriate value.

The exosuit model generation system generates at least a portion of a personalized exosuit model that includes the component having (i) a region shaped to correspond to a contour of the person's body and (ii) an actuator housing at the actuator housing location (208). The exosuit model generation system can generate a new personalized exosuit model, customize a template exosuit model, e.g., a portion of a template exosuit model, or a combination of both. For instance, the exosuit model generation system can determine the portion of a person's body for which the personalized exosuit model should be generated, e.g., an elbow. The exosuit model generation system can determine that a database of exosuit models includes a template exosuit model for some of the portion of the person's body, e.g., for the person's aftarm, but not for the entire portion of the person's body, e.g., the person's forearm. This can occur when the person had a prior injury that changed a shape of some of the portion of the person's body, e.g., the person previously broke their forearm and the forearm did not heal straight or in a correct position. The exosuit model generation system can then generate a new personalized exosuit model for the person's forearm while customizing a template exosuit model for the person's aftarm.

In some implementations, customizing a template exosuit model can include selecting a template exosuit model from multiple template exosuit models stored in a database. For instance, the exosuit model generation system can determine a template exosuit model using a function that determines a fit between a template exosuit model and the portion of the person's body, as represented by the three-dimensional data model of the portion. The exosuit model generation system can determine a fit between each of multiple template exosuit models and the three-dimensional data model and select, from the multiple template exosuit models, the model with the closest fit for the three-dimensional data model.

The exosuit model generation system can determine the closest fit using one or more threshold criteria. A first threshold criteria can indicate a maximum distance between the template exosuit model and the three-dimensional data model. A second threshold criteria can indicate a minimum distance between the template exosuit model and the three-dimensional data model.

When the exosuit model generation system determines that a template exosuit model does not have a consistent fit with the three-dimensional data model, e.g., some parts of the template exosuit model are closer to the three-dimensional data model, the exosuit model generation system can combine data, e.g., fit measures, for the different areas to determine a fit. For instance, the exosuit model generation system can combine data for areas that are closer than the minimum distance, data for areas that are further than the maximum distance, or both, to determine a fit measure for a template exosuit model. The exosuit model generation system can then select a template exosuit model that has the best fit measure from multiple template exosuit models.

The exosuit model generation system can adjust the shape, e.g., contour, of one or more components in an exosuit model, whether a template exosuit model or not. For example, the exosuit model generation system can use data about the fit between the exosuit model and the three-dimensional data model to adjust the shape of the exosuit model. For areas of the exosuit model for which the distance between the exosuit model and the three-dimensional data model do not satisfy the first threshold criteria, e.g., are greater than the maximum distance, the exosuit model generation system can move the shape of the exosuit model closer to the three-dimensional data model. For areas of the exosuit model for which the distance between the exosuit model and the three-dimensional data model do not satisfy the second threshold criteria, e.g., are less than the minimum distance, the exosuit model generation system can move the shape of the exosuit model away from the three-dimensional data model. Using these adjustments, the exosuit model generation system can adjust the exosuit model so that each area of the exosuit model satisfies both the first threshold criteria and the second threshold criteria, e.g., has a distance from the three-dimensional data model that is between the maximum distance and the minimum distance, optionally inclusive of the threshold distance values.

In some implementations, the exosuit model generation system can position one or more components to surround the actuator housing locations. For instance, the exosuit model generation system can determine a size of an actuator housing and select a component, e.g., a plate, that is larger than the size. The exosuit model generation system can place the selected component in the personalized exosuit model in an area that includes the actuator housing location.

In some implementations, the exosuit model generation system can select a template exosuit model, from a database of template exosuit models, using the one or more actuator housing locations. For instance, the exosuit model generation system can select a template exosuit model that includes components in areas that surround each of the one or more actuator housing locations such that the components can include a corresponding actuator housing.

The exosuit model generation system can generate the personalized exosuit based on a use type for a personalized exosuit that can be created using the personalized exosuit model. For instance, when the use type is running, the exosuit model generation system can select a fabrication material that is stronger than if the use type were walking. Some examples of use types include an activity type, injury support, e.g., for injuries that will not likely heal completely, rehabilitation, a class of users for which the personalized exosuit model is created, e.g., children, adults, or elderly persons. Some activity types can include walking, running, climbing, sports, or lifting.

In some implementations, the exosuit model generation system can make structural changes to a template exosuit model, or create a new exosuit model, based on the use type. For instance, the exosuit model generation system can include more support components, connector components, or both, for more demanding activities than lighter activities. In some implementations, the exosuit model generation can include three connector components to attach a first support component to a second support component for a personalized knee exosuit for a runner while only including two connector components to attach the first support component to the second support component for a personalized knee exosuit for a walker.

The exosuit model generation system can determine locations for other components while generating the personalized exosuit model. Other components can include sensors, cables, or control boards. The exosuit model generation system can determine the locations for the other components using data, processes, or both, such as those described with reference to determinations made for an actuator housing location.

In some implementations, the exosuit model generation system can optimize one or more parameters for a personalized exosuit model. The optimization can include balancing benefits, detriments, or both, for the one or more parameters. For example, the exosuit model generation system can include a constraint that indicates that a personalized exosuit model should have as little weight as possible. However, when the exosuit model generation system generates a personalized exosuit model for a more demanding activity, the exosuit model generation system can use a constraint that indicates a minimum exosuit strength for the more demanding activity. Although this might require a heavier exosuit weight, going against the weight constraint, the exosuit model generation system can generate a personalized exosuit model for a personalized exosuit with a heavier weight to satisfy the strength constraint. Other constraints can include a maximum exosuit size, a minimum exosuit size, an exosuit stiffness, an exosuit flexibility, an exosuit heat conductance, or a combination of two or more of these. Exosuits used for more demanding activities can have a higher heat conductance, e.g., to dissipate heat, than those used for less demanding activities.

The constraints, and corresponding parameters, can be for the entire personalized exosuit model or a portion of a personalized exosuit model. For instance, a personalized exosuit model can have an overall maximum size constraint and individual constraints for flexibility, stiffness, and weight for different components, or combinations of components, included in the personalized exosuit model.

In some implementations, the exosuit model generation system can modify a template exosuit model. The exosuit model generation system can modify the template exosuit model using data for the three-dimensional data model. For example, the exosuit model generation system can modify the template exosuit model based on a detected size and/or shape of the three-dimensional data model, or the portion of the three-dimensional data model. Specifically, the exosuit model generation system can adjust a default size of one or more support components and/or connector components of the template exosuit model using the detected sizes and/or shapes of the three-dimensional data model. The exosuit model generation system can modify the template exosuit model using characteristics for a user, e.g., user parameters. For example, the exosuit model generation system can take into account a determined left leg and right leg length of a user when modifying the template exosuit model.

In modifying the template exosuit model, the exosuit model generation system can adjust the size of one or more support components in the template exosuit model, the shape of one or more support components in the template exosuit model, the size of one or more connector components in the template exosuit model, the shape of one or more connector components in the template exosuit model, the number of support components in the template exosuit model, the number of connector components in the template exosuit model, or a combination of two or more of these.

In modifying the template exosuit model, the exosuit model generation system can use one or more algorithms, such as one or more machine learning algorithms. The exosuit model generation system can use these one or more algorithms to, for example, adjust a size of one or more support components in the template exosuit model based on the three-dimensional data model, to adjust a size of one or more connector components in the template exosuit model based on the three-dimensional data model, to adjust a number of support components in the template exosuit model based on the three-dimensional data model, to adjust a number of connector components in the template exosuit model based on the three-dimensional data model, or a combination of two or more of these. The one or more machine learning algorithms can receive the three-dimensional data model, or data for the model, as input. The one or more machine learning algorithms can also receive user parameters, exosuit constraints, or both, as input.

The adjustments made by the one or more algorithms to the components of the template exosuit model can be refinements on the detected size, detected shapes, or both, of portions of the three-dimensional data model. For example, the exosuit model generation system can adjust a size and/or shape of a component of the template exosuit model using the one or more algorithms based on the three-dimensional data model, the user parameters, or both. The resulting component size and/or shape can have a different size and/or shape than the detected size and/or shape of the corresponding portion of the three-dimensional data model. That is, the one or more algorithms can adjust the size and/or shape of the component to account for other factors, e.g., to account for particular characteristics of a user, to avoid components having certain angles or shapes (that might be uncomfortable for a person, that might introduce pressure points, or the like), to account for stresses that components need to be able to handle, to account for imperfections that can arise from clothing worn during generation of the three-dimensional data model not perfectly fitting a user, to account for imperfections that can arise during scanning, to account for areas where a user needs additional support due to a previous injury or surgery, to account for support needs that correspond to a condition of a user (e.g., disease or disorder the user suffers from), or the like.

In some implementations, the exosuit model generation system can receive data that indicates administrator input for one or more adjustments to a personalized exosuit model. The exosuit model generation system can receive the data at any appropriate time during the process 200, e.g., during step 206, step 208, step 210, or a combination of these. For example, the exosuit model generation system can receive data that indicates administrator adjustment of the size of one or more support components in a modified template exosuit model, the shape of one or more support components in the modified template exosuit model, the size of one or more connector components in the modified template exosuit model, the shape of one or more connector components in the modified template exosuit model, the number of support components in the modified template exosuit model, the number of connector components in the modified template exosuit model, or a combination of two or more of these.

The exosuit model generation system simulates a use of an exosuit using the personalized exosuit model and the three-dimensional data model (210). For instance, a simulation engine included in the exosuit model generation system simulates the use of the personalized exosuit model to ensure that the exosuit model satisfies one or more threshold criteria. The criteria can indicate a freedom of movement for a person who wears the exosuit, e.g., a physical exosuit created using the personal exosuit model.

The exosuit model generation system can perform the simulation using an avatar that makes realistic movements while wearing the personalized exosuit model in a virtual environment. The exosuit model generation system can generate the avatar using the three-dimensional data model. The avatar can be of an entire person or a portion of a person, e.g., the portion that would wear an exosuit created using the personalized exosuit model.

The exosuit model generation system can select movements based on one or more user parameters, a health condition, or both. For instance, when the user parameters indicate one or more use types, e.g., walking and jogging, the exosuit model generation system can select walking and jogging movements for the avatar. When the health condition indicates a knee injury, the exosuit model generation system can select movements that include a knee, e.g., the up and down movement of the legs while jogging. When the health condition indicates an arm injury, the exosuit model generation system can select movements that include an arm, e.g., the forward and backward movement of an arm while jogging.

The exosuit model generation system determines whether data for the simulation satisfy a threshold criteria (212). The threshold criteria can indicate minimum performance requirements for an exosuit created using the personalized exosuit model. Some threshold criteria include a minimum freedom of movement, an amount of support the exosuit will likely provide a user, a likelihood of future injury, a rehabilitation duration, or other appropriate threshold criteria. The satisfaction of the threshold criteria can include all threshold criteria for a personalized exosuit model or a subset of threshold criteria for a personalized exosuit model, e.g., as discussed in more detail below.

In response to determining that the data for the simulation satisfy the threshold criteria, the exosuit model generation system stores the personalized exosuit model in a memory (214). The memory can be any appropriate type of memory. The memory can be a database that maintains personalized exosuit models. The database can include data that references a person for whom the personalized exosuit model was created.

In response to determining that the data for the simulation do not satisfy the threshold criteria, the exosuit model generation system modifies one or more parameters for the personalized exosuit model using the data that do not satisfy the threshold criteria (216). For instance, the exosuit model generation system performs one or more modifications as discussed above with reference to steps 206, 208, or both. When the parameters indicate that particular threshold criteria are not satisfied, the exosuit model generation system can perform one or more modifications specifically based on those unsatisfied threshold criteria. For example, when a freedom of movement threshold criteria is not satisfied, the exosuit model generation system can adjust a location of an actuator housing, a plate, a connector, or a combination of these.

In some implementations, in response to determining that the data for the simulation do not satisfy the threshold criteria, the exosuit model generation system determines to not modify the exosuit model. For instance, when the exosuit model generation system has five threshold criteria, three of which are satisfied and two of which are not, the exosuit model generation system can determine to not modify the exosuit model. This can occur when the exosuit model generation system determines that satisfying some threshold criteria prevents a personalized exosuit model from satisfying all of the threshold criteria, e.g., when a weight threshold criteria cannot be satisfied at the same time as a minimum strength threshold criteria.

The exosuit model generation system provides, to a three-dimensional printer, the personalized exosuit model and an instruction to print one or more components of a physical exosuit based on the personalized exosuit model (218). This can include all components of the physical exosuit that are capable of being printed by a printer, e.g., other than the components that will attach to the housings included in the physical exosuit. The components can include the support components, the connector components, and other components into which the housings can be integrated.

The instruction to print the physical exosuit can cause the three-dimensional printer to create the physical exosuit using the personalized exosuit model. The three-dimensional printer can be any appropriate type of printer.

The order of steps in the process 200 described above is illustrative only, and generating the exosuit model can be performed in different orders. For example, the exosuit model generation system can receive the three-dimensional data model and then determine the exosuit position data.

In some implementations, the process 200 can include additional steps, fewer steps, or some of the steps can be divided into multiple steps. For example, the exosuit model generation system can perform steps 202, 206, and 208 without performing the other steps in the process 200. In some implementations, the exosuit model generation system can perform steps 202, 206, 208, 210, 212, and 214 without performing the other steps in the process 200. The exosuit model generation system can perform steps 202, 206, 208, 210, 212, and 216 without performing the other steps in the process 200.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HyperText Markup Language (HTML) page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A system comprising one or more computers and one or more storage devices on which are stored instructions that are operable, when executed by the one or more computers, to cause the one or more computers to perform operations comprising:
receiving a three-dimensional data model of one or more areas of a person's body;
determining exosuit position data that identifies a portion of the three-dimensional data model for which an exosuit model will be generated, the portion of the three-dimensional data model corresponding to a portion of the person's body included in the one or more areas of the person's body;
determining, using the three-dimensional data model and the exosuit position data, an actuator housing location to integrate an actuator housing in a component of the exosuit model, the actuator housing location being determined to align a first movement path for an actuator received in the actuator housing with a second movement path for the person's body; and
based on the three-dimensional data model, the exosuit position data, and the actuator housing location, generating at least a portion of an exosuit model that includes the component having (i) a region shaped to correspond to a contour of the person's body and (ii) an actuator housing at the actuator housing location.

2. The system of claim 1, the operations comprising selecting an attachment feature that is configured to attach the actuator to the actuator housing,
wherein generating at least the portion of the exosuit model comprises generating at least the portion of the exosuit model that includes the component having the actuator housing at the actuator housing location and the attachment feature connected to the actuator housing.

3. The system of claim 1, the operations comprising determining a component of a template exosuit model located within a threshold distance of the actuator housing location using the exosuit position data and the actuator housing location,
wherein generating at least the portion of the exosuit model that includes the component comprises customizing the component from the template exosuit model to have the actuator housing at the actuator housing location.

4. The system of claim 3, wherein determining the component of the template exosuit model located within the threshold distance of the actuator housing location comprises selecting a support component that is located at the actuator housing location.

5. The system of claim 3, the operations comprising determining whether a size for the component satisfies one or more criteria using one or more properties for the actuator,
wherein customizing the component from the template exosuit model to have the actuator housing at the actuator housing location comprises customizing the component from the template exosuit model to have the actuator housing at the actuator housing location and a size that satisfies the one or more criteria when the size does not satisfy the one or more criteria.

6. The system of claim 4, wherein determining the component of the template exosuit model located within the threshold distance of the actuator housing location comprises:
selecting a component from multiple components included in the template exosuit model using the size for the component and the actuator housing locations.

7. The system of claim 6, wherein determining the actuator housing location comprises:
determining a region of the template exosuit model in which to place the actuator housing for the actuator;
determining two or more exosuit components that are in the region of the template exosuit model;
selecting, from the two or more exosuit components, a component in which to place the actuator housing using one or more of a strength for the component, a size for the component, or a flexibility for the component.

8. The system of claim 4, wherein the one or more properties for the actuator comprise one or more of an actuator size, an actuator weight, or an actuator power.

9. The system of claim 1, the operations comprising providing, to a three-dimensional printer, the exosuit model and an instruction to print one or more components of a physical exosuit based on the exosuit model.

10. The system of claim 1, wherein determining the actuator housing location to align a first movement path for an actuator received in the actuator housing with a second movement path for the person's body comprises determining an actuator housing location that aligns a position of an actuator, placed in the actuator housing at the actuator housing location, with a center of a joint for the portion of the person's body.

11. The system of claim 1, wherein determining the actuator housing location to align a first movement path for an actuator received in the actuator housing with a second movement path for the person's body comprises determining an actuator housing location to align movement of an actuator, placed in the actuator housing at the actuator housing location, with movement of a joint for the portion of the person's body.

12. The system of claim 1, wherein determining the exosuit position data comprises receiving the exosuit position data that identifies the portion of the three-dimensional data model that corresponds to a portion of the person's body that has a health condition.

13. The system of claim 1, the operations comprising:
determining, using the three-dimensional data model and the exosuit position data, a sensor housing location to integrate a sensor housing in a second component of the exosuit model, the sensor housing location being determined to enable a sensor, received in the sensor housing, to monitor the person's body or an environment in which the person's body is located,
wherein generating at least the portion of the exosuit model comprises generating at least the portion of the exosuit model that includes the second component having (i) a second region shaped to correspond to a contour of the person's body and (ii) a sensor housing at the sensor housing location.

14. The system of claim 1, the operations comprising:
determining, using the three-dimensional data model and the exosuit position data, a cable housing location to integrate a cable housing in a second component of the exosuit model, the cable housing location being determined to enable a cable, received in the cable housing, to connect a control board with another component of an exosuit while minimizing an amount that movement of a person's body is limited by the cable,
wherein generating at least the portion of the exosuit model comprises generating at least the portion of the exosuit model that includes the second component having (i) a second region shaped to correspond to a contour of the person's body and (ii) a cable housing at the cable housing location.

15. The system of claim 1, the operations comprising:
determining, using the three-dimensional data model and the exosuit position data, a control board housing location to integrate a control board housing in a second component of the exosuit model, the control board housing location being determined to minimize an amount of movement of a person's body that is limited by a control board received in the control board housing,
wherein generating at least the portion of the exosuit model comprises generating at least the portion of the exosuit model that includes the second component having (i) a second region shaped to correspond to a contour of the person's body and (ii) a control board housing at the control board housing location.

16. The system of claim 1, the operations comprising simulating a use of an exosuit using the exosuit model and the three-dimensional data model of the one or more areas of the person's body.

17. The system of claim 16, the operations comprising:
determining whether data for the simulation satisfy one or more threshold criteria; and
in response to determining that data for the simulation satisfy the one or more threshold criteria, storing the exosuit model in a memory and determining to not modify the exosuit model.

18. The system of claim 16, the operations comprising:
determining whether data for the simulation satisfy a threshold criteria; and
in response to determining that data for the simulation does not satisfy the threshold criteria, modifying one or more parameters for the exosuit model using the data that do not satisfy the threshold criteria.

19. The system of claim 1, wherein generating at least the portion of the exosuit model comprises generating at least the portion of the exosuit model using one or more structural integrity design rules.

20. The system of claim 1, wherein generating at least the portion of the exosuit model comprises selecting a fabrication material for a physical exosuit that can be created using the exosuit model, or a size of one or more components for the exosuit model while minimizing a weight for the physical exosuit and maintaining a minimum strength for the physical exosuit.

21. A non-transitory computer storage medium encoded with instructions that, when executed by one or more computers, cause the one or more computers to perform operations comprising:
receiving a three-dimensional data model of one or more areas of a person's body;
determining exosuit position data that identifies a portion of the three-dimensional data model for which an exosuit model will be generated, the portion of the three-dimensional data model corresponding to a portion of the person's body included in the one or more areas of the person's body;
determining, using the three-dimensional data model and the exosuit position data, an actuator housing location to integrate an actuator housing in a component of the exosuit model, the actuator housing location being determined to align a first movement path for an actuator received in the actuator housing with a second movement path for the person's body; and
based on the three-dimensional data model, the exosuit position data, and the actuator housing location, generating at least a portion of an exosuit model that includes the component having (i) a region shaped to correspond to a contour of the person's body and (ii) an actuator housing at the actuator housing location.

22. A computer-implemented method comprising:
receiving a three-dimensional data model of one or more areas of a person's body;
determining exosuit position data that identifies a portion of the three-dimensional data model for which an exosuit model will be generated, the portion of the three-dimensional data model corresponding to a portion of the person's body included in the one or more areas of the person's body;
determining, using the three-dimensional data model and the exosuit position data, an actuator housing location to integrate an actuator housing in a component of the exosuit model, the actuator housing location being determined to align a first movement path for an actuator received in the actuator housing with a second movement path for the person's body; and
based on the three-dimensional data model, the exosuit position data, and the actuator housing location, generating at least a portion of an exosuit model that includes the component having (i) a region shaped to correspond to a contour of the person's body and (ii) an actuator housing at the actuator housing location.
